(19) United States
(12) Patent Application Publication
(10) Pub. No.: US 2005/0152270 A1
(43) Pub. Date: Jul. 14, 2005

(54) Policy-based qos management in multi-radio access networks

(76) Inventors: Gerardo Gomez Paredes, Marbella (ES); Hector Montes Linares, Granada (ES); Zhi-Chun Honkasalo, Kauniainen (FI); Jeroen Wigard, Aalborg (DE); Javier Romero Garcia, Malaga (ES)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/510,697

(22) PCT Filed: Apr. 12, 2002
(86) PCT No.: PCT/IB02/01194

(51) Int. Cl. H04L 12/26

(52) U.S. Cl. 370/229

(57) ABSTRACT

A system for providing a policy based Quality-of-Service management in multi-radio access mobile networks, comprising: control center means for administrating said radio access networks, thereby controlling the behavior thereof, wherein information model is implemented in said control center means which describes different Quality-of-Service mechanisms including attributes which are involved in each function under policy thus representing the manageable parameters of specific network implementations, and wherein said information model forms the basis of a set of policy rules defining actions to be executed in dependency of the occurrence of conditions; and a policy based management device adapted to receive said set of rules for the implementation thereof, said device having a plurality of policy based radio resource management means each adapted for managing said parameters of specific network implementations, and a translation function means adapted to translate said rules in a form executable by said plurality of policy based radio resource management means.

### FIELD OF THE INVENTION

The present invention relates to a system and method for providing a policy based Quality-of-Service management in multi-radio access mobile networks.

### BACKGROUND OF THE INVENTION

Mobile networks are subject to a big expansion over the world in the sense of major diversity of devices and services. With respect to a best-effort service model, mobile networks are intended to support different service levels for specific Quality-of-Service (QoS) requirements.

However, this growth in network usage and technology has increased the network management complexity in fields such as Quality-of-Service. Hence, the main challenge is the complexity for operators to manage their networks in a simple way and to offer the possibility to regulate the access to network resources based on categories such as user profiles or applications. An additional complexity arises from the management of multi-radio networks, e.g. when an operator deploys a WCDMA (Wideband Code Division Multiple Access) and a GSM/GPRS (Global System for Mobile Communication/General Packet Radio System) network simultaneously.

In addition to the heterogeneity of new services with different Quality-of-Service requirements, the management of networks becomes more complex due to technology divergence, i.e. the presence of multi-radio access networks (GERAN—GSM EDGE Radio Access Network, UTRAN—Universal Terrestrial Radio Access Network), and the growth in the complexity of the network elements, i.e. many parameters take influence on the functions thereof.

### SUMMARY OF THE INVENTION

Therefore, it is an object of the present invention to deal with the above described problems.

According to the present invention, the problem of managing complex networks is solved with a policy management system and method which are system level unified for managing the Quality-of-Service in multi-radio access mobile networks.

Precisely, there is provided a system for providing a policy based Quality-of-Service management in multi-radio access mobile networks, comprising: control center means for administrating said radio access networks, thereby controlling the behavior thereof, wherein an information model is implemented in said control center means which describes different Quality-of-Service mechanisms including attributes which are involved in each function under policy thus representing the manageable parameters of specific network implementations, and wherein said information model forms the basis of a set of policy rules defining actions to be executed in dependency of the occurrence of conditions; and a policy based management device adapted to receive said set of rules for the implementation thereof, said device having a plurality of policy based radio resource management means each adapted for managing said parameters of specific network implementations, and a translation function means adapted to translate said rules in a form executable by said plurality of policy based radio resource management means.

In addition, there is provided a method of providing a policy based Quality-of-Service management in multi-radio access mobile networks, comprising the steps of: defining an information model by modeling radio Quality-of-Service functions, abstracting implementation details from configuration and management parameters thereof, identifying manageable parameters of these, and building policy rules for the execution of certain actions in dependency of the occurrence of certain conditions among said manageable parameters; evaluating the conditions; and executing, in dependency from said evaluation step, those actions which are prescribed by said policy rules as a consequence from the occurrence of certain conditions, wherein said policy rules are administrated by a central controlling point if they take effect on the Quality-of-Service behavior at the network level.

According to the policy based radio resource management of the present invention, a centralized control point is offered which administrates the network in order to achieve a consistent service behavior for the need of a specific Quality-of-Service. That means that all Quality-of-Service related functions distributed in the radio access network could be managed from a central point of administration. In addition, policy based radio is an integral part of a larger network-wide policy management framework, so that the operator's network-wide policy can be enforced consistently across radio (L2) technologies which are independent from each other.

Furthermore, the policy based management according to the present invention allows to allocate resources in terms of business decisions, since abstracted management data can be used. For abstraction purposes, an information model describes the different Quality-of-Service mechanisms, including the attributes involved in each function under policy. The informal management model is intended to be abstract and capable of representing the manageable parameters for a variety of specific radio access network element implementations.

According to the present invention, a policy based management is provided by means of which a network administrator-is able to configure a set of rules expressed, for example, in human (business) vocabulary. These rules are independent of the radio access technology, since the policy based management system hides the implementation technologic details. The policy management system translates high level policies (service policies) into network specific policies, which can be understood and enforced by the multi-radio resource management (RRM) functions (i.e. both GERAN and UTRAN RRM).

The policy based radio resource management, which is part of the policy based management tool, is responsible for managing Quality-of-Service in radio access networks (RAN), thereby covering functions like admission control for new Radio Access Bearers (RAB) and Radio Bearers (RB) or a dynamic configuration of the packet scheduler, the load control or of quality control parameters. From the viewpoint of policy management, those radio resource management (RRM) functions of different radio technology are modeled as black boxes which provide certain “services” towards the policy management system. The services of the functionality are described by an information model which is common for different kinds of radio resource management (RRM) implementations. It is also possible that one radio specific technology comprises a subset of the full service capability.

On the abstract level, the service capability of a radio resource management (RRM) black box can be seen as a Differentiated Service—able router containing a Quality-of-Service agent (i.e. having signaling capability). The radio resource management (RRM) black box contains e.g. a traffic classification, a queue management (packet dropper, en-queuing, and scheduling), a flow based admission control, and flow based quality control functions, for both uplink and downlink traffic. Each of these functions has a set of configurable attributes, which can be set by a policy server. The radio resource management (RRM) black box can be either WCDMA or GERAN, or a multi-radio network of WCDMA and GERAN, WLAN (Wireless Local Area Network) or some other system. For a multi-radio RRM black box, the policy manager controls all resources of the different networks.

According to the present invention, the policy based management allows to control the behavior of the boxes (e.g. the throughput and the delay distributions) for different types of traffic flow.

Advantageous modifications of the present invention are defined in the appended dependent claims, while further details of the present invention are apparent from the following description of the embodiments thereof which is to be taken in conjunction with the appended drawings, in which:

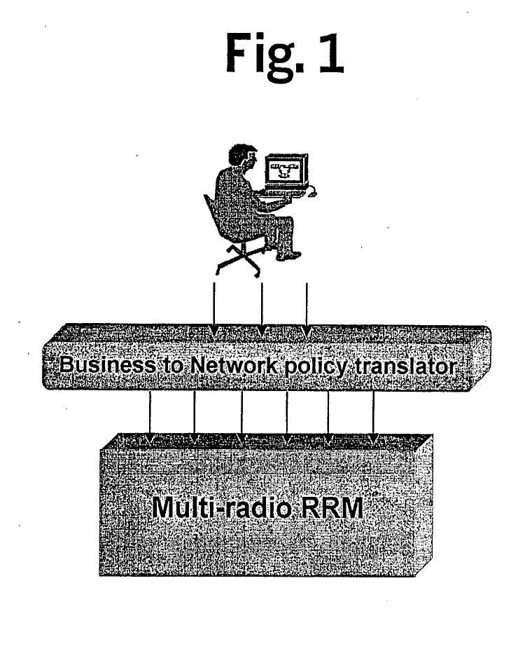

FIG. 1 shows a policy-based Quality-of-Service management;

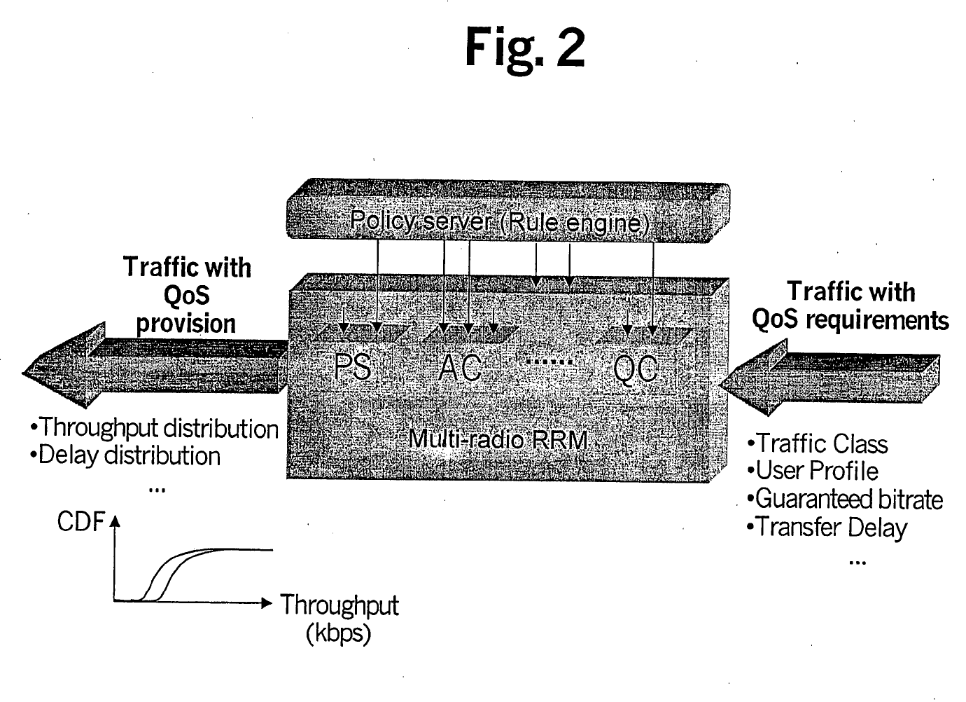

FIG. 2 shows a system management model;

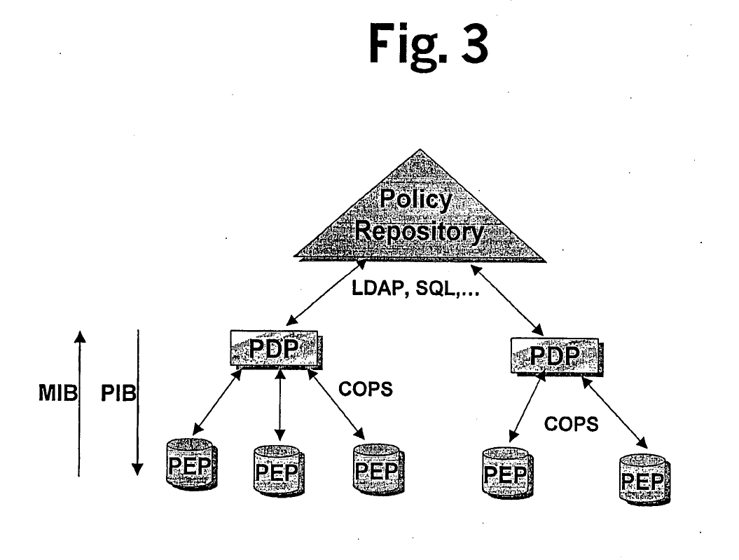

FIG. 3 shows a policy model; and

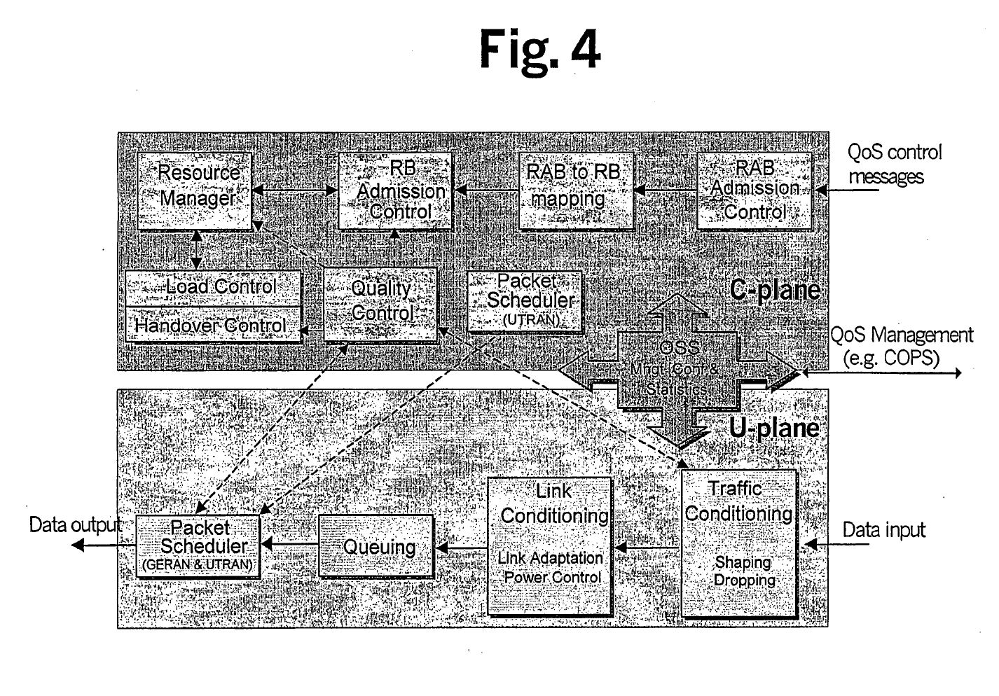

FIG. 4 shows a radio Quality-of-Service functional block coordination.

### PREFERRED EMBODIMENTS OF THE PRESENT INVENTION

By referring to FIG. 1, a policy-based Quality-of-Service management according to the present invention is described.

As depicted in the figure, a network administrator is able to configure a set of rules expressed, for example, in human (business) vocabulary. The rules are independent of the radio access technology, since the policy-based management hides those technologic implementation details. Furthermore, there is a function translating high level policies (service policies) into network specific policies, which are processable by the radio resource management (RRM) functions. Moreover, those network specific policies are applicable to multi-radio access networks, i.e. to radio resource management functions of e.g. both GERAN and UTRAN.

Next, a system management model according to the present invention is described with reference to FIG. 2.

The different radio resource management functions, such as e.g. a packet scheduler PS, an admission control AC and a quality control QC, are modeled as black boxes, where only the functionality and the parameters controlling its behavior are important. From the whole set of parameters, only a subset of them are selected to be managed by the policy rules. The selected parameters are those impacting on the Quality-of-Service provision and those the value of which can dynamically be varied by the operator, unlike configuration parameters. In the figure, this idea is outlined by means of two types of arrows: those interacting with the policy server and those remaining within the radio resource management subsystem which can not be dynamically configured by the operator.

Furthermore, the multi-radio resource management system is seen as a black box by the policy server. The inputs of the system are different traffic flows with different Quality-of-Service requirements (traffic class, user profile, guaranteed bit rate, transfer delay, etc.), whereas the outputs are those traffic flows with a determined Quality-of-Service provision, e.g. a determined throughput distribution and delay distribution. As a consequence, the policy based management according to the present invention allows to control the behavior of the system (e.g. throughput and delay distributions) for different types of traffic flow. This idea is depicted in the figure by means of two different cumulative distribution functions CDF of the throughput as produced by two different sets of values of the policy parameters.

Referring now to FIG. 3, the policy model according to the present invention is described hereinafter.

This policy model is composed by three types of entities: A policy repository is the location containing high-level policies as defined by the administrator which can be applied within the policy domain. A policy enforcement point PEP represents the entity whose behavior is going to be managed by the policy rules. A policy decision point PDP represents a group of functions in charge of acquiring, deploying, and optionally translating policy rules into a form understandable and thus executable by a policy enforcement point PEP.

The downloading of the rules from the policy decision points PDP into the policy enforcement points PEP is effected by a policy information base PIB which contains the possible rules of all relevant functions of a specific device. The policy enforcement points PEP are monitored and provided with simple configuration tasks by a management information base MIB which informs about the behavior of the policy enforcement points PEP. The management information base MIB is defined for monitoring and behavior control purposes.

Moreover, with reference to FIG. 4 a radio Quality-of-Service functional blocks coordination is described below.

The components and combinations of components as described in the figure form building blocks that need to be manageable by radio access network configuration and management tools. This model is in the form of a connected Directed Acyclic Graph (DAG) of elements that describes not only the admission control and resource management functions at the service activation, but also the traffic conditioning and queuing behaviors which any particular packet will experience when forwarded to the radio interface.

Radio configuration and performance indicator operating parameters are monitored and provisioned through the management interface. The monitored parameters include statistics regarding a traffic carried at various Quality-of-Service levels. The network administrator interacts with the radio element configuration and management interfaces via one or more management protocols, such as the Simple Network Management Protocol (SNMP) or the Common Open Policy Service (COPS), or through other configuration tools such as the Remote Authentication Dial-in User Service (RADIUS) or the Lightweight Directory Access Protocol (LDAP).

In the following, the preferred embodiments of the present invention are described in even more detail by referring to the above.

In order to apply a proper policy management to the radio domain, different radio Quality-of-Service functions must be modeled abstracting the implementation details from the parameters of interest for configuration and management. Once the manageable parameters are identified, the operator is able to build policy rules in the form “IF condition THEN action”.

The semantics of a policy rule are such that if the set of conditions evaluates to TRUE then the set of actions are executed. The scope of these rules can vary: Global policies will have a global effect on the overall result of applying the given policy. That is, the end result of such policy relies on it being executed globally across the entire path of network service. Further, domain policies are meaningful within one domain of Quality-of-Service mechanisms, e.g. a radio domain, whereas local policies are only meaningful within one network element. From the viewpoint of rule management, it is very essential that the global and domain policies are harmonized. This target is presently considered to be easiest achieved by-means of a central controlling point. Local policies can reside within the control of a corresponding local element, so long as such local policies have no effect on the Quality-of-Service globally.

In the radio domain, most of the policy decision functions are distributed into various control and user plane logical elements, so that dynamic policy decisions, in particular the time critical ones, can be made locally based on local dynamic conditions. However, the service logic of these policy decision elements is under the control and administration of a policy server.

Policy information must be transmitted to a network device for the purpose of configuring the policy at that device (see FIG. 3). The policy information base PIB defines the data structure by which the policy decision point PDP downloads the policy into a policy enforcement point PEP. Each policy information base. PIB contains the possible rules of all relevant functions of a specific device. In addition, the management information base MIB is defined for the purpose of monitoring and simple configuration of network devices. The management information base MIB defines the device specific data structure by which the policy enforcement point PEP may inform its behavior to the policy decision point PDP.

A policy infrastructure is that set of protocols, information models, and services that allow administrative and business intentions to be translated into a differential packet treatment of network packet flows. The exchange of information between different types of entities needs the use of protocols in charge of that (see FIG. 3). The Common Open Policy Service COPS protocol is a client-server protocol intended for the communication of policy requests and decisions between a policy enforcement point PEP and a policy decision point PDP. The Common Open Policy Service COPS is characterized by its reliability and fault-tolerance unlike a legacy control protocol such as the Simple Network Management Protocol SNMP. Furthermore, the Common Open Policy Service COPS is flexible and easy to use for both a dynamic and static configuration. Depending on the type of policy repository, the access to the policy repository can be performed by different protocols such as the Lightweight Directory Access Protocol LDAP or the Structured Query Language SQL.

The first step towards the policy management is defining an information model to describe the different Quality-of-Service mechanisms, including the attributes involved in each function that can be under policy (see FIG. 2). The informal management model is intended to be abstract and capable of representing the manageable parameters for a variety of specific radio access network element implementations. This model serves as the rationale for the design of the policy information bases PIB of the different network elements.

The policy management in the radio domain is responsible for managing the Quality-of-Service in the radio access network, covering functions like admission control AC for new radio access bearers RAB and radio bearers RB or dynamically configuring the packet scheduler, load control or quality control parameters. Those radio resource management functions are modeled as black boxes, where it is only the functionality and the parameters controlling its behavior are important. The selected parameters are those impacting on the Quality-of-Service provision and operators can dynamically vary its value, unlike configuration parameters. In addition, the multi-radio RRM system is seen as a black box by the policy server (see FIG. 1). The inputs of the system are different traffic flows with different Quality-of-Service requirements (traffic class, user profile, guaranteed bit rate, transfer delay, etc.), whereas the outputs are those traffic flows with a determined Quality-of-Service provision, e.g. a determined throughput distribution and delay distribution. As a consequence, the policy based management according to the present invention allows to control the behavior of the system (e.g. the throughput and delay distributions) for different types of traffic flow.

By means of the policy based management according to the present invention, a network administrator is able to configure a set of rules expressed, for example, in human (business) vocabulary and being independent of the radio access technology, since the policy based management hides those implementation technologic details (see FIG. 1). The policy server translates high level policies (service policies) into network specific policies, which are understandable and executable by the radio resource management functions. Moreover, those network specific policies are applicable to multi-radio access networks, i.e. to radio resource management functions of both GERAN and UTRAN.

Next it is described what is presently considered as the best mode of implementing the present invention.

The present invention can be implemented with a policy server type of product, which comprises a user interface for the network administrator to enter and/or select a policy. In addition, there is a configuration data base present where all parameters are stored. It is a function of the policy server that a submitted policy is checked first for service logic consistency, and consequently a new or updated data structure is generated based on the policy update. The data structure is element specific.

The exchange of information between different types of entities (i.e. a policy decision point PDP and a policy enforcement point PEP) needs the use of protocols in charge thereof. The Common Open Policy Service COPS protocol is a client-server protocol intended for the communication of policy requests and decisions between a policy enforcement point PEP and a policy decision point PDP. The Common Open Policy Service COPS is characterized by its reliability and fault-tolerance unlike legacy control protocols such as the Simple Network Management Protocol (SNMP). Furthermore, the Common Open Policy Service COPS is flexible and easy to use for both a dynamic and static configuration. Depending on the type of policy repository, the access to the policy repository can be performed by different protocols such as the Lightweight Directory Access Protocol (LDAP) or the Structured Query Language (SQL).

Thus, important features are how policy based management is performed and that the policy server product is able to configure radio (see as L2) Quality-of-Service-functions to be consistent with the network layer Quality-of-Server policy, according to the operator network wide policy. This is visible in the policy server user interface. In addition, the policy server is able to configure multiple radio technology with one set of rules corresponding to the information model as used by multiple radio technologies in the network.

In summary, what is described above is a system for providing a policy based Quality-of-Service management in multi-radio access mobile networks, comprising: control center means for administrating said radio access networks, thereby controlling the behavior thereof, wherein an information model is implemented in said control center means which describes different Quality-of-Service mechanisms including attributes which are involved in each function under policy thus representing the manageable parameters of specific network implementations, and wherein said information model forms the basis of a set of policy rules defining actions to be executed in dependency of the occurrence of conditions; and a policy based management device adapted to receive said set of rules for the implementation thereof, said device having a plurality of policy based radio resource management means each adapted for managing said parameters of specific network implementations, and a translation function means adapted to translate said rules in a form executable by said plurality of policy based radio resource management means.

In addition, there is provided a method of providing a policy based Quality-of-Service management in multi-radio access mobile networks, comprising the steps of: defining an information model by modeling radio Quality-of-Service functions, abstracting implementation details from configuration and management parameters thereof, identifying manageable parameters of these, and building policy rules for the execution of certain actions in dependency of the occurrence of certain conditions among said manageable parameters; evaluating the conditions; and executing, in dependency from said evaluation step, those actions which are prescribed by said policy rules as a consequence from the occurrence of certain conditions, wherein said policy rules are administrated by a central controlling point if they take effect on the Quality-of-Service behavior at the network level.

While it is described above what is presently considered as the preferred embodiments of the present invention it is apparent to those skilled in the art that various modifications thereof are possible without departing from the scope of the present invention which is defined by what is set out in the appended claims.

1. A system for providing a policy based Quality-of-Service management in multi-radio access mobile networks, comprising:
control center means for administrating said radio access networks, thereby controlling the behavior thereof,
wherein an information model is implemented in said control center means which describes different Quality-of-Service mechanisms including attributes which are involved in each function under policy thus representing the manageable parameters of specific network implementations, and
wherein said information model forms the basis of a set of policy rules defining actions to be executed in dependency of the occurrence of conditions; and
a policy based management device adapted to receive said set of rules for the implementation thereof,
said device having
a plurality of policy based radio resource management means each adapted for managing said parameters of specific network implementations, and
a translation function means adapted to translate said rules in a form executable by said plurality of policy based radio resource management means.

2. A system according to claim 1, wherein said set of rules is implemented in a policy server.

3. A system according to claim 1, wherein said control center means comprises a user interface for entering and/or selecting a policy according to a specific subset of rules.

4. A system according to claim 1, wherein said control center device further comprises a configuration data base for storing said parameters.

5. A system according to claim 1, said system further comprising:
policy enforcement means representing entities whose behavior is going to be managed by said policy rules;
policy decision means defining a group of functionalities in charge of acquiring, deploying and translating said policy rules into a form executable by said policy enforcement means;
policy repository means for containing the policies defined an administrator of said radio access networks;
management information base means for informing about the behavior of said policy enforcement means; and
policy information base means for containing possible rules of all relevant functions of a specific policy enforcement means so that said rules can be downloaded by said policy decision means into said policy enforcement means.

6. A method of providing a policy based Quality-of-Service management in multi-radio access mobile networks, comprising the steps of:
defining an information model by
modeling radio Quality-of-Service functions,
abstracting implementation details from configuration and management parameters thereof,
identifying manageable parameters of these, and
building policy rules for the execution of certain actions in dependency of the occurrence of certain conditions among said manageable parameters;
evaluating the conditions; and
executing, in dependency from said evaluation step, those actions which are prescribed by said policy rules as a consequence from the occurrence of certain conditions,
wherein said policy rules are administrated by a central controlling point if they take effect on the Quality-of-Service behavior at the network level.

7. A method according to claim 6, wherein submitted policy rules are checked for their service logic consistency.

8. A method according to claim 6, wherein a data structure is generated by a management information base which is specific for a point where a policy rule is enforced.

9. A method according to claim 6, comprising the further step of
distributing functions resulting from policy rules into logical elements of control nature and/or user nature for enabling local decisions on local conditions, wherein the service logic of said elements remains under the control and administration of a policy server.
